(19) United States
(12) Patent Application Publication
(10) Pub. No.: US 2004/0100055 A1
(43) Pub. Date: May 27, 2004

(54) Skateboard with safety alert system

(76) Inventor: Carlos Martin Sequra Chang, Downey, CA (US)

Correspondence Address: Raymond Y. Chan, Suite 128, 108 N. Ynez Avenue, Monterey Park, CA, 91754, US

(21) Appl. No.: 10/304,170

(22) Filed: Nov. 25, 2002

(51) Int. Cl. B62M 1/00

(52) U.S. Cl. 280/87.042

(57) ABSTRACT

A skateboard includes a step board and two wheel assemblies spacedly mounted underneath the step board, wherein each of the wheel assemblies includes two wheels and a truck unit. The truck unit includes a truck having two side ends rotatably mount the two wheels respectively, a washer pad mounted between the step board and the truck, and a safety alert system which includes a power source supported underneath the step board and at least an illuminator electrically connected to the power source, wherein the illuminator is positioned at an exterior of the truck to provide a light effect for enhancing a visibility of the skateboard so as to prevent unwanted accidents and improve safety.

### BACKGROUND OF THE PRESENT INVENTION

1. Field of Invention

The present invention relates to a skateboard, and more particularly to a skateboard with a safety alert system which can generate an alerting signal to notify others around the skateboard player so as to prevent unwanted accidents and improve safety.

2. Description of Related Arts

Nowadays, skateboards are well known and have been considered as a form of transportation, recreation, and exercise. A conventional skateboard comprises a step board and two wheel assemblies spacedly attached underneath the step board, wherein each of the wheel assemblies comprises a truck, two wheels rotatably connected to two side ends of the truck respectively, and a washer pad mounted between the truck and the step board for retaining the truck on the step board in position.

It is well known that vehicular collisions are one of the most common accidents occurring on the streets today that result in countless loss of money, time, and sometimes, lives. Therefore, a safety device is important for the skateboard players to prevent from unwanted accidents.

Unlike the skateboard, numerous safety devices can be employed with a bicycle to protect the bikers from injury. The safety devices, such as reflector, can be worn by the bikers or mounted on the bicycle to increase biker visibility. Therefore, other vehicle drivers are capable of being notified the biker through the light reflection and keeping a safety distance from the biker.

Due to the use of the skateboard, it is difficult for the skateboard players to install the safety device into the skateboard. One of the safety devices is a wheel light which is mounted to the wheel of the skateboard wherein the wheel light energizes responsive to the rotational movement of the wheel, so that the light turns on when the skateboard is moving to enhance the visibility of the moving skateboard. However, most of the skateboard players would like to do some tricks such as grinding and jumping. Those tricks require the truck scratching on a sliding surface such as a curb or the wheels hitting on the ground. As a result, the safety device will be broken while performing those tricks.

Moreover, the skateboard player requires a sudden acceleration and deceleration such that other vehicle driver cannot adequately observe the skateboard player approaching from the surroundings to keep the safety distance away from the skateboard player. In other words, no particular safety device has been introduced to aid the skateboard player in passively notifying other vehicle drivers in surroundings.

### SUMMARY OF THE PRESENT INVENTION

A main object of the present invention is to provide a skateboard with a safety alert system which can generate alert signals to notify others around the skateboard player so as to prevent unwanted accidents and improve safety.

Another object of the present invention is to provide a skateboard with a safety alert system, wherein the safety alert system additionally provides added visibility to the skateboard in dark conditions, so as to aid the skateboard player in passively notifying other vehicle drivers in surroundings.

Another object of the present invention is to provide a skateboard with a safety alert system, wherein the safety alert system is positioned underneath the step board of the skateboard with a distance away from the wheel to prevent the safety alert system from being damaged while performing the skateboard tricks.

Another object of the present invention is to provide a skateboard with a safety alert system, wherein the safety alert system is capable of incorporating with any existing skateboard while being cost effective by merely replacing its washer pads according to one embodiment.

Another object of the present invention is to provide a skateboard with a safety alert system, wherein the safety alert system does not require altering the original structural design of the skateboard so as to minimize the manufacturing cost of the skateboard incorporating with the safety alert system.

Another object of the present invention is to provide a skateboard with a safety alert system, wherein no expensive or complicated structure is required to employ in the present invention in order to achieve the above mentioned objects. Therefore, the present invention successfully provides an economic and efficient solution for not only providing a safety configuration to the skateboard player but also enhancing the appearance and visibility of the moving skateboard.

Accordingly, in order to accomplish the above objects, the present invention provides a skateboard, comprising:

a step board; and

two wheel assemblies spacedly mounted underneath the step board, wherein each of the wheel assemblies comprises:

two wheels;

a truck unit which comprises:

a truck affixed to a bottom surface of the step board, wherein said two wheels are rotatably mounted at two side ends of the truck respectively; and

a washer pad mounted between the bottom surface of the step board and the truck; and

a safety alert system, comprising:

a power source supported underneath the step board; and

at least an illuminator electrically connected to the power source, wherein the illuminator is positioned on said truck unit to provide a lighting effect for enhancing a visibility of the skateboard.

### BRIEF DESCRIPTION OF THE DRAWINGS

FIG. 1 is an exploded perspective view of a skateboard with a safety alert system according to a first preferred embodiment of the present invention.

FIG. 2 is a sectional view of the safety alert system of the skateboard according to the above first preferred embodiment of the present invention.

FIG. 3 illustrates a first alternative mode of the safety alert system of the skateboard according to the above first preferred embodiment of the present invention.

FIG. 4 illustrates a second alternative mode of the safety alert system of the skateboard according to the above first preferred embodiment of the present invention.

FIG. 5 is an exploded perspective view of a skateboard with a safety alert system according to a second preferred embodiment of the present invention.

FIG. 6 is a sectional view of the safety alert system of the skateboard according to the above second preferred embodiment of the present invention.

### DETAILED DESCRIPTION OF THE PREFERRED EMBODIMENT

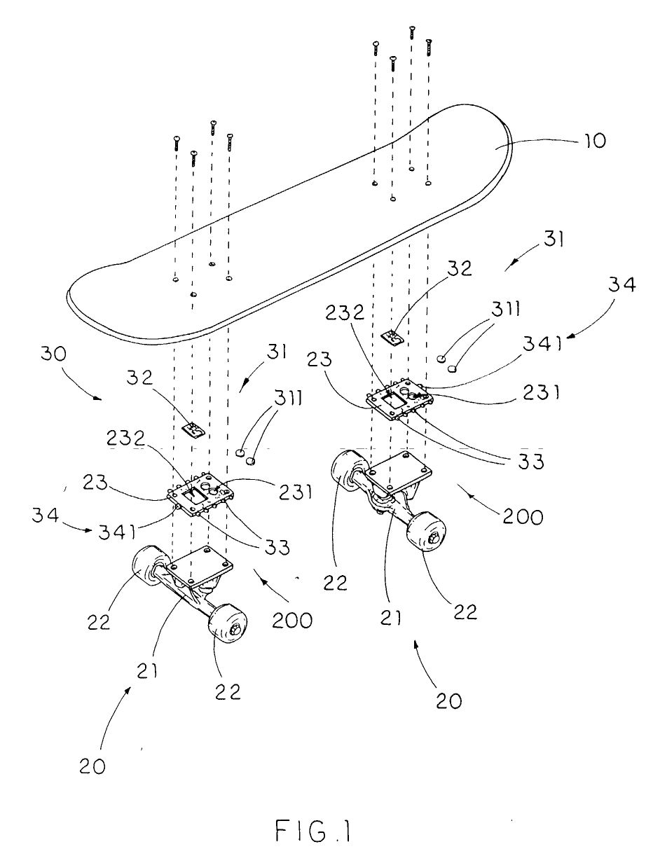

Referring to FIG. 1 of the drawings, a skateboard according to a first preferred embodiment of the present invention is illustrated, wherein the skateboard, such as a conventional skateboard, comprises a step board 10 and two wheel assemblies 20 spacedly mounted underneath the step board 10, wherein each of the wheel assemblies 20 comprises two wheels 22 and a truck unit 200.

The truck unit 200 comprises a truck 21 affixed to a bottom surface of the step board 10 wherein the two wheels 22 are rotatably mounted at two side ends of the truck 21 respectively, a washer pad 23 mounted between the step board 10 and the truck 21, and a safety alert system 30.

The safety alert system 30 comprises a power source 31 supported underneath the step board 10 and at least an illuminator 33 electrically connected to the power source 31, wherein the illuminator 32 is positioned at the truck unit 200 to provide a light effect for enhancing a visibility of the skateboard.

According to one embodiment of the present invention, the power source 31 comprises an electrical circuit 32 electrically connected with the illuminator 33 and at least a replaceable battery 311 (there are two batteries as shown in Figures) enclosed and protected by the washer pad 23 in such a manner that when the power battery 311 is out of power, the skateboard player is able to replace a new battery easily. It is worth to mention that each of the wheel assemblies 20 can be unscrewed to dissemble from the step board 10 so that the skateboard player is able to change the optimum truck 21 and wheels 22 to enhance the skateboard performance. Therefore, the replacement of the power source 31 is easy and simple for the skateboard player.

According to the preferred embodiment, the washer pad 23 is made of durable material, such as plastic or rubber, such that when the metal made truck 21 is mounted on a bottom side of the step board 10, the washer pad 23 is capable of not only retaining the truck 21 in position but also absorbing the vibration from the wheels 22 through the step board 10.

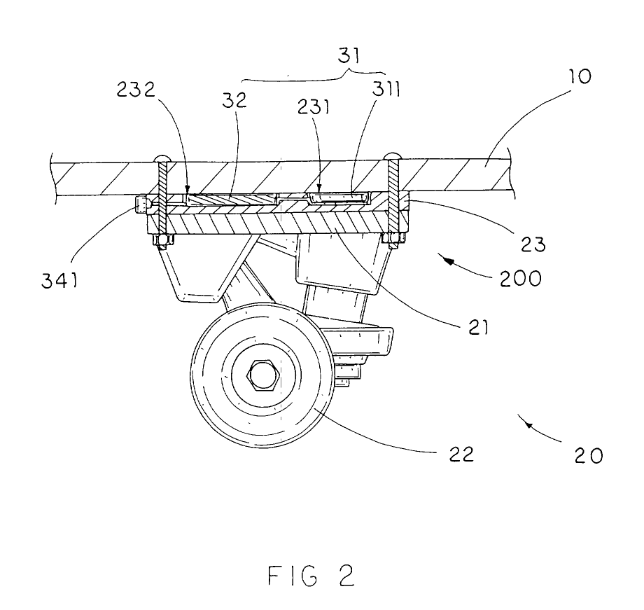

The washer pad 23, having a pad body, has a battery compartment 231 to receive the batteries 31 1 therein and a receiving cavity 232 to receive the electrical circuit 32 in such a manner that the power source 31 and the electrical circuit 32 are protected by the washer pad 23 so as to prevent the any collision of the safety alert system 30. In other words, when the washer pad 23 is sandwiched between the truck 21 and the step board 10, the electrical circuit 32 is received in receiving cavity 232 of the washer pad 23 at a position covered by the step board 10, as shown in FIG. 2. Since the skateboard trick requires the truck 21 or the wheels 22 sliding on the sliding surface, the washer pad 23 is capable of not only retaining the position of the truck 21 with respect to the step board 10 but also protect the electrical circuit 32 from being impacted.

In addition, the batteries 311 and the electrical circuit 32 are water sealed and protected in the washer pad 23 since the washer pad 23 is sealedly mounted underneath the step board 10 in a waterproof manner, so as to prevent water entering into the receiving cavity 232 and protect the electrical circuit 32 disposed in the washer pad 23.

The illuminator 33, according to the preferred embodiment, is a light emitting diode (LED) sidewardly mounted on the washer pad 23 wherein a head portion of the light emitting diode of the illuminator 33 is outwardly protruded from the washer pad 23 in such a manner that the light generated from the illuminator 33 is passing to outside so as to enhance the visibility of the skateboard. Accordingly, the illuminator 33 is capable producing a light flashing effect with different colors so as to further enhance the attractive ornamentation of the skateboard.

As shown in FIG. 1, there is a plurality of illuminators 33 spacedly extended at two sides of the washer pad 23 in such a manner that when the illuminators 33 are switched on, the illuminators 33 provide a light effect to enhance the appearance of the skateboard as well.

The safety alert system 30 further comprises a switching means 34 for switching the illuminator 33 in an on/off manner. The switching means 34 comprises a light sensor 341 electrically connected to the electrical circuit 32 wherein the light sensor 341 functions as an auto-switch for switching on the illuminator 33 at a predetermined light intensity level. Therefore, during the daytime, the illuminator 33 is automatically switched off to save energy for as long as the batteries 311 last. In a dark condition, the illuminator 33 is automatically switched on via the light sensor 341 to provide additional visibility to the skateboard so as to improve safety.

Alternatively, the safety alert system 30 can be constructed as an additional reinforcing layer mounted between the washer pad 23 and the step board 10, such that the skateboard player is able to simply install the safety alert system 30 into the existing skateboard without changing the original configuration thereof. Therefore, the additional reinforcing layer and the washer pad 23, which are sandwiched between the truck 21 and the step board 10, are capable of further absorbing the vibration towards the step board 10 during impacting the truck 21.

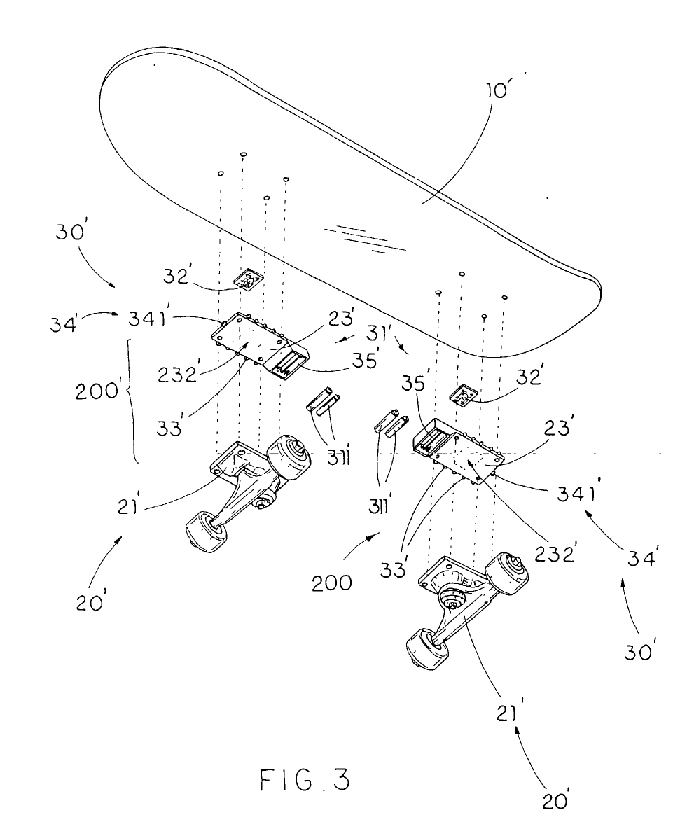

FIG. 3 illustrates a first alternative mode of the safety alert system 30′ which further has a battery housing 35′ extended from the washer pad 23′ for receiving the batteries 311′, wherein the battery housing 35′ is supported underneath the step board 10 at an inner side of the respective wheel assembly 20′ such that the batteries 311′ are capable of being replaced without dissembling the wheel assembly 20′.

As shown in FIG. 3, the electrical circuit 32′ is disposed in the receiving cavity 232′ of the washer pad 23′ and is electrically connected to the batteries 311′ of the power source 31′ which is received in the battery housing 35′ in such a manner that the illuminator 33′ is automatically switched on via the light sensor 341′ of the switching means 34′ in a dark condition. In other words, the skateboard player is able to replace the batteries 311′ of the power source 31′ without detaching the truck 21′ from the step board 10′.

It is worth to mention that the light sensor 341′ can be substituted by a manual switch to turn on and off the illuminator 33′ so that the skateboard player is able to switch on the safety alert system 30′ manually to provide lighting signals anytime.

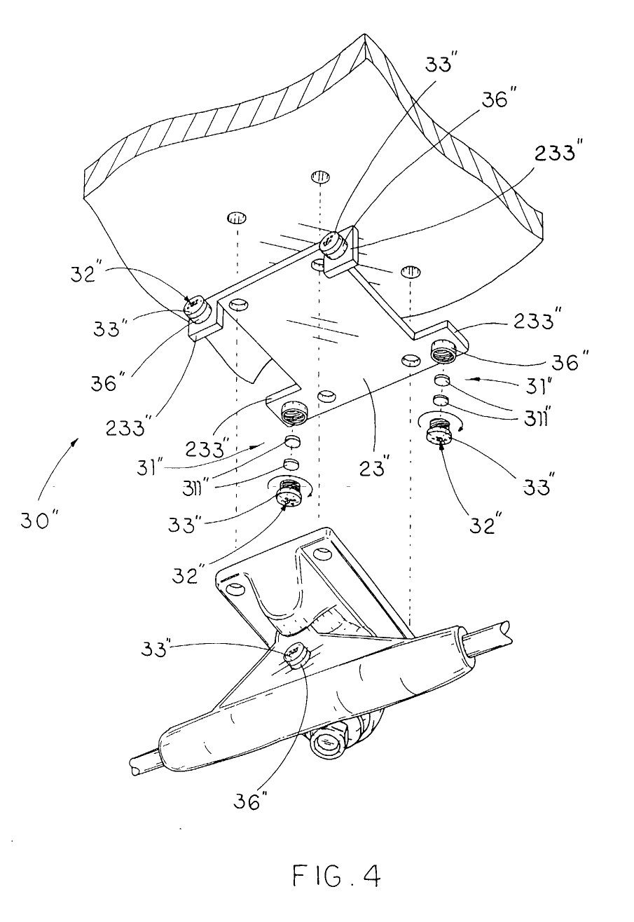

FIG. 4 illustrates a second alternative mode of the safety alert system 30″ wherein the washer pad 23′ further comprises at least a side support 233′ extended outwardly. The safety alert system 30″ further comprises a light housing 36″ mounted on the side support 233″ of the washer pad 23″ to receive the power source 31″ wherein the illuminator 33″ is mounted in the light housing 36″ to electrically connect with the power source 31″.

Accordingly, the electrical circuit 32″ is built-in with the illuminator 33″ wherein the battery 311″ is disposed in the light housing 36″ such that when the illuminator 33″ is mounted in the light housing 36″, the illuminator 33″ is electrically connected to the battery 311″ in contacting manner so as to generate the light from the illuminator 33″.

The illuminator 33″ is rotatably mounted in the light housing 36″ and is arranged in such a manner that when the illuminator 33″ is tightly screwed in the light housing 36″, the illuminator 33″ is electrically contacted with the power source 31″ for producing the lighting effect. In other words, the skateboard player is able to switch on the safety alert system by tightly turning the illuminator 33″ into the light housing 36″ until the illuminator 33″ contacts with the power source 31″ and to switch off the safety alert system by loosing the illuminator 33″ with respect to the light housing 36″.

As shown in FIG. 4, the illuminator 33″ can be mounted at the truck 21″, wherein the light housing 36″ is embedded on a front side of the truck 21″ in such a manner that the illuminator 33″ is rotatably mounted in the light housing 36″ at a position that the light from the illuminator 33″ is capable of directing forwardly as an alerting head light of the skateboard.

In addition, the side support 233″ is extended from the washer pad 23″ at a position that the illuminator 33″ is facing forward in such a manner that when the safety alert system 30″ is switched on, the light from the illuminator 33″ is directed forwardly, so as to further enhance the visibility of the skateboard, as shown in FIG. 4.

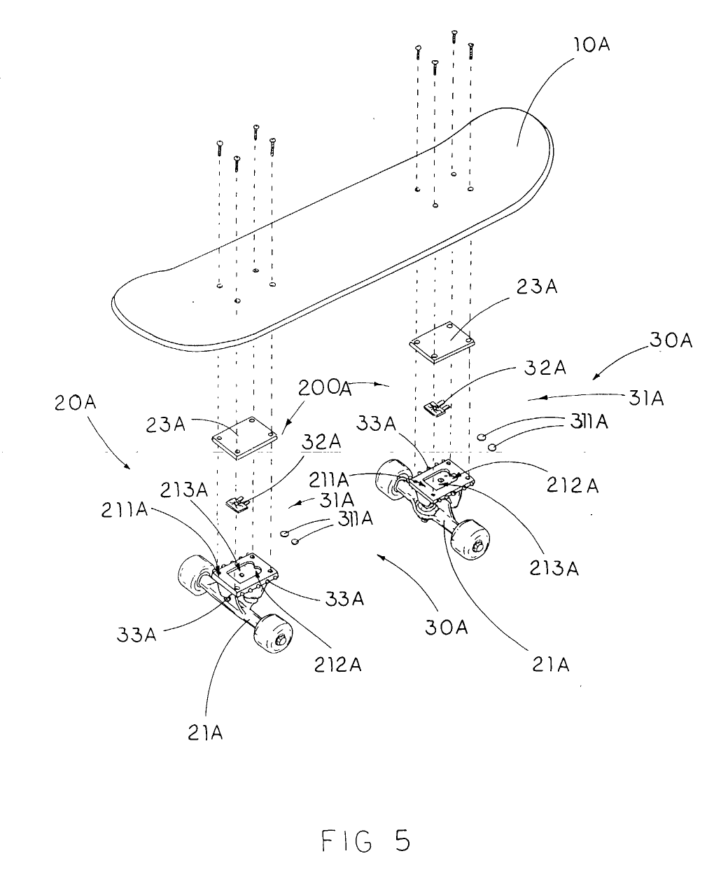

As shown in FIG. 5, the skateboard with the safety alert system 20A of a second embodiment illustrates an alternative mode of the first embodiment of the present invention, wherein the safety alert system 30A in incorporated with the truck 21A of the respective wheel assemble 20A.

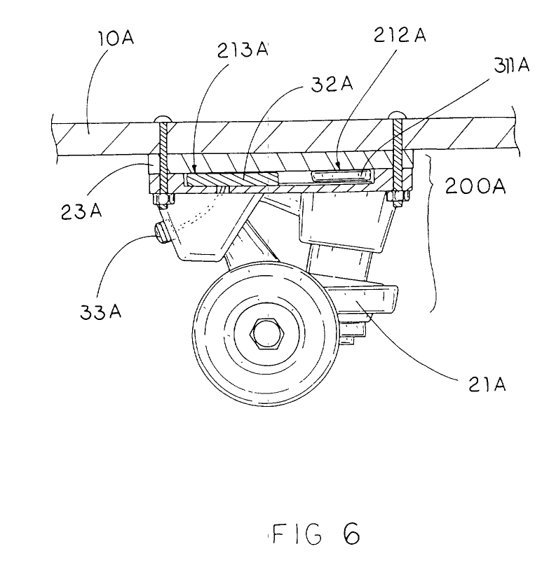

The truck 21A has an upper surface 211A wherein the washer pad 23A is sandwiched between the upper surface 211A and the bottom surface of the step board 10A. The truck 21A further has a battery compartment 212A formed on the upper surface 211A to receive the batteries 311A and a receiving cavity 213A to receive the electrical circuit 32A so as to electrically connect with the batteries 311A in such a manner that the batteries 311A and the electrical circuit 32A of the power source 31A are enclosed in and protected by the truck 21A, as shown in FIG. 6.

In addition, the illuminator 33A is sidewardly mounted on the truck 21A wherein a head portion of the illuminator 33A is outwardly protruded from the truck 21A in such a manner that the light generated from the illuminator 33A is passing to outside. The illuminator 33A can also mounted on a front side and/or a rear side of the truck 21A to further enhance the visibility of the skateboard.

It is worth to mention that the safety alert system 30 according to the first embodiment is incorporated with the washer pad 23 such that the skateboard player is able to only change the washer pad 23 of the skateboard for safety purpose. However, the safety alert system 30A according to the second embodiment is mainly used for a new skateboard since the safety alert system 30A is built-in with the truck 21A.

In accordance with the preferred embodiments and their alternative modes, as disclosed above, the original structure of the skateboard does not require to be altered in order to incorporate with the safety alert system for increasing the visibility of the skateboard. Moreover, there is no limitation of the type of the illuminator to provide different light effect of the skateboard, so as to enhance the decorative skateboard of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A skateboard, comprising:
a step board; and
two wheel assemblies spacedly mounted underneath said step board, wherein each of said wheel assemblies comprises:
two wheels; and
a truck unit which comprises:
a truck affixed to a bottom surface of said step board, wherein said two wheels are rotatably mounted at two side ends of said truck respectively; and
a washer pad securely mounted between said bottom surface of said step board and said truck;
wherein at least one of said wheel assemblies further comprises a safety alert system which comprises:
a power source supported underneath said step board; and
at least one illuminator electrically connected to said power source, wherein said illuminator is mounted on said truck unit to provide a lighting effect for enhancing a visibility of said skateboard.

2. A skateboard, as recited in claim 1, wherein said power source comprises an electrical circuit electrically connected with said illuminator and received in a receiving cavity formed on said washer pad in such a manner that when said washer pad is sandwiched between said truck and said step board, said electrical circuit is covered by said step board.

3. A skateboard, as recited in claim 1, wherein said power source comprises at least a battery electrically connected with said at least one illuminator and said washer pad has a battery compartment formed thereon to receive said battery.

4. A skateboard, as recited in claim 2, wherein said power source further comprises at least a battery electrically connected with said at least one illuminator and said washer pad has a battery compartment formed thereon to receive said battery.

5. A skateboard, as recited in claim 1, wherein said illuminator is a light emitting diode mounted on said washer pad, wherein a head portion of said light emitting diode of said illuminator is outwardly extended from said washer pad to expose outside.

6. A skateboard, as recited in claim 4, wherein said illuminator is a light emitting diode mounted on said washer pad, wherein a head portion of said light emitting diode of said illuminator is outwardly extended from said washer pad to expose outside.

7. A skateboard, as recited in claim 4, wherein said safety alert system further comprises means for switching said illuminator on and off.

8. A skateboard, as recited in claim 6, wherein said safety alert system further comprises means for switching said illuminator on and off.

9. A skateboard, as recited in claim 3, wherein said safety alert system further comprises a battery housing attached to said truck unit to receive said battery, wherein said battery housing is supported underneath said step board without obstructing a rotation of said wheels of said wheel assembly.

10. A skateboard, as recited in claim 4, wherein said safety alert system further comprises a battery housing attached to said truck unit to receive said battery, wherein said battery housing is supported underneath said step board without obstructing a rotation of said wheels of said wheel assembly.

11. A skateboard, as recited in claim 10, wherein said illuminator is a light emitting diode mounted on said washer pad, wherein a head portion of said light emitting diode of said illuminator is outwardly extended from said washer pad to expose outside.

12. A skateboard, as recited in claim 10, wherein said safety alert system further comprises means for switching said illuminator on and off.

13. A skateboard, as recited in claim 11, wherein said safety alert system further comprises means for switching said illuminator on and off.

14. A skateboard, as recited in claim 1, wherein said washer pad comprises at least a side support extended outwardly and said safety alert system further comprises a light housing mounted on said side support of said washer pad to receive said power source, wherein said illuminator is mounted in said light housing to electrically connect with said power source.

15. A skateboard, as recited in claim 14, wherein said power source comprises an electrical circuit built-in with said illuminator and a battery disposed in said light housing in such a manner that when said illuminator contacts with said replaceable battery within said light housing, said illuminator is electrically connected with said battery to provide said light effect.

16. A skateboard, as recited in claim 14, wherein said side support is extended from said washer pad at a position that said illuminator is facing forward in such a manner that when said safety alert system is switched on, a light generated by said illuminator is directed forwardly.

17. A skateboard, as recited in claim 15, wherein said side support is extended from said washer pad at a position that said illuminator is facing forward in such a manner that when said safety alert system is switched on, a light generated by said illuminator is directed forwardly.

18. A skateboard, as recited in claim 14, wherein said illuminator is rotatably mounted in said light housing in such a manner that said illuminator is switched on when said illuminator is tightly screwed in said light housing until said illuminator contacts with said power source and said illuminator is switched off by loosing said illuminator with respect to said light housing.

19. A skateboard, as recited in claim 15, wherein said illuminator is rotatably mounted in said light housing in such a manner that said illuminator is switched on when said illuminator is tightly screwed in said light housing until said illuminator contacts with said power source and said illuminator is switched off by loosing said illuminator with respect to said light housing.

20. A washer pad for a skateboard which comprises a step board and two wheel assemblies each comprising a truck mounted underneath said step board and two wheels rotatably mounted at two side ends of said truck, wherein said washer pad, adapted for mounting between said step board and said truck, comprises:
a pad body; and
a safety alert system, which is disposed in said pad body, comprising a power source adapted for supporting underneath said step board and at least one illuminator electrically connected to said power source to provide a lighting effect for enhancing a visibility of said skateboard.

21. The washer pad, as recited in claim 20, wherein said power source comprises an electrical circuit electrically connected with said illuminator and received in a receiving cavity formed on said pad body, thereby when said washer pad is mounted between said truck and said step board, said electrical circuit is covered by said step board.

22. The washer pad, as recited in claim 20, wherein said power source comprises at least a battery electrically connected with said at least one illuminator and said pad body has a battery compartment formed thereon to receive said battery.

23. The washer pad, as recited in claim 21, wherein said power source comprises at least a battery electrically connected with said at least one illuminator and said pad body has a battery compartment formed thereon to receive said battery.

24. The washer pad, as recited in claim 20, wherein said illuminator is a light emitting diode mounted on said pad body, wherein a head portion of said light emitting diode of said illuminator is outwardly extended from said pad body to expose outside.

25. The washer pad, as recited in claim 23, wherein said illuminator is a light emitting diode mounted on said pad body, wherein a head portion of said light emitting diode of said illuminator is outwardly extended from said pad body to expose outside.

26. The washer pad, as recited in claim 20, further comprising at least a side support extended outwardly and a light housing mounted on said side support to receive said power source, wherein said illuminator is mounted in said light housing to electrically connect with said power source.

27. The washer pad, as recited in claim 26, wherein said power source comprises an electrical circuit built-in with said illuminator and a battery disposed in said light housing in such a manner that when said illuminator contacts with said battery within said light housing, said illuminator is electrically connected with said battery to provide said lighting effect.
